(19) United States
(12) Patent Application Publication
(10) Pub. No.: US 2004/0022548 A1
(43) Pub. Date: Feb. 5, 2004

(54) Image forming apparatus and error resetting method

(75) Inventor: Yasuhiro Nagaoka, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/207,107

(22) Filed: Jul. 30, 2002

(51) Int. Cl. G03G 15/00

(52) U.S. Cl. 399/16; 399/19; 399/21

(57) ABSTRACT

A main CPU causes a sheet jam indicator in a status display portion to blink when a sensor unit detects a sheet jam, produces a correct action sound when a cover related to the jam cleaning process is opened, and produces an error sound when a cover unrelated to the jam cleaning process is opened.

### BACKGROUND OF THE INVENTION

The present invention relates to image forming apparatuses such as a digital copy machine which reads an image of a document and forms an image based on the read image, and to an error resetting method in which errors such as a jam caused in the image forming apparatus are reset.

In a conventional digital multi functional peripheral (MFP), to perform copying, scanning, facsimile reception, and printing, a document is conveyed to a sheet supply mechanism, and a sheet is conveyed to a print/sheet discharge mechanism to complete the printing. Moreover, also in a facsimile apparatus, the document or the sheet is similarly conveyed.

When a jam occurs at sheet supply time, or print/sheet discharge time, a process is immediately discontinued, and jam information is detected by a sensor disposed in the place where the jam has occurred.

The jam information is notified to a user by display using a liquid crystal display (LCD) or a light emitting diode (LED). The user clears and recovers the jam by a manual operation.

However, since a jam recovery operation is a manually performed operation, a wrong operation such as the opening of another cover is easily caused during a recovery operation (during a jam cleaning operation). Moreover, even when such wrong operation is performed, it is difficult to confirm a correct part of the operation, and it has been impossible to clearly grasp the correct operation.

Furthermore, in the structure, a jam error cannot be eliminated until the jam is completely cleared. Therefore, jam recovery is achieved by performing the correct operation including the wrong operation and this causes a problem that the process cannot be quickly performed.

### BRIEF SUMMARY OF THE INVENTION

An object of the present invention is to provide an image forming apparatus and error resetting method in which an operation for recovery can be clarified and speeded up at the time of jam occurrence.

To achieve the object, according to the present invention, there is provided an image forming apparatus which reads an image of a document and forms an image on a supplied sheet based on the read image, the apparatus comprising: a detection unit which detects a conveyance error of the document or sheet; a judgment unit to judge whether a resetting process is a correct or wrong resetting process, when the resetting process is performed with respect to the conveyance error detected by the detection unit; a first notification unit to notify that the resetting process is correct, when the judgment unit judges the resetting process to be correct; and a second notification unit to notify that the resetting process is wrong, when the judgment unit judges the resetting process to be wrong.

According to the present invention, there is provided an error resetting method of an image forming apparatus which reads an image of a document and forms an image on a supplied sheet based on the read image, the method comprising: detecting a conveyance error of the document or sheet; judging whether a resetting process is a correct or wrong resetting process, when the resetting process is performed with respect to the detected conveyance error; notifying that the resetting process is correct, when the resetting process is judged to be correct; and notifying that the resetting process is wrong, when the resetting process is judged to be wrong.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a sectional view showing an inner structure of a digital multi functional peripheral related to an image forming apparatus of the present invention;

FIG. 2 is a plan view showing a constitution of an operation panel;

FIG. 3 is a block diagram showing a schematic constitution of the digital multi functional peripheral;

FIG. 4 is a flowchart showing a setting to notify guidance;

FIG. 5 is a flowchart showing a jam recovery operation;

FIG. 6 is an explanatory view of an operation example of a jam process;

FIG. 7 is an explanatory view of the operation example of the jam process;

FIG. 8 is an explanatory view of the operation example of the jam process; and

FIG. 9 is an explanatory view of the operation example of the jam process.

### DETAILED DESCRIPTION OF THE INVENTION

One embodiment of the present invention will be described hereinafter with reference to the drawings.

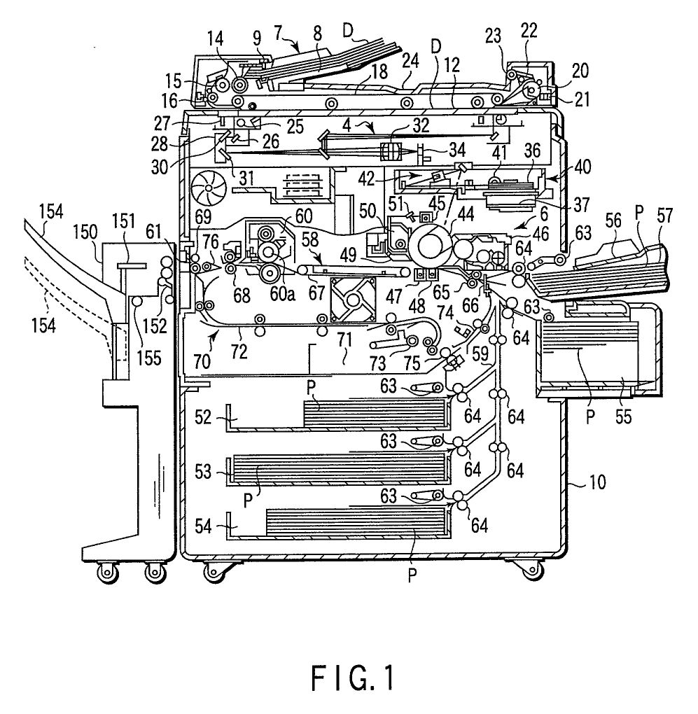

FIG. 1 is a sectional view showing an inner structure of a digital multi functional peripheral (MFP) related to an image forming apparatus of the present invention.

As shown in FIG. 1, a digital multi functional peripheral includes an apparatus main body 10, and in the apparatus main body 10, there are disposed a scanner section 4 which functions as an image read section, and a printer section 6 which functions as an image forming section.

A document laying base 12 formed of transparent glass on which a read object, that is, a document D, is laid is disposed on an upper surface of the apparatus main body 10. Moreover, on the upper surface of the apparatus main body 10, an automatic document feeder 7 (hereinafter referred to as the ADF) which automatically feeds the document onto the document laying base 12 is disposed. The ADF 7 is disposed so as to be openable/closable with respect to the document laying base 12, and also functions as a document press which brings the document D laid on the document laying base 12 into close contact with the document laying base 12.

The ADF 7 includes: a document tray 8 on which the document D is set; an empty sensor 9 which detects presence/absence of the document; a pickup roller 14 which picks up the document sheets from the document tray 8 sheet by sheet; a sheet supply roller 15 which conveys the extracted document; an aligning roller pair 16 which aligns tip ends of the document sheets; and a conveyance belt 18 disposed so that substantially the whole document laying base 12 is covered. Moreover, a plurality of document sheets set upwards on the document tray 8 are extracted in order from the lowermost page, that is, the last page, aligned by the aligning roller pair 16, and conveyed onto a predetermined position of the document laying base 12 by the conveyance belt 18.

In an end portion of the ADF 7 on a side opposite to the aligning roller pair 16 via the conveyance belt 18, a reverse roller 20, non-reverse sensor 21, flapper 22, and sheet discharge roller 23 are disposed. The document D whose image information is read out by the scanner section 4 described later is fed out of the document laying base 12 by the conveyance belt 18, and discharged onto a document discharge portion 24 on the upper surface of the ADF 7 via the reverse roller 20, flapper 21, and sheet discharge roller 22. To read a back surface of the document D, when the flapper 22 is switched, the document D conveyed by the conveyance belt 18 is reversed by the reverse roller 20, and thereafter fed onto a predetermined position of the document laying base 12 again by the conveyance belt 18.

The scanner section 4 disposed in the apparatus main body 10 includes: an exposure lamp 25 as a light source which illuminates the document D laid on the document laying base 12; and a first mirror 26 which deflects a reflected light from the document D in a predetermined direction. The exposure lamp 25 and first mirror 26 are attached to a first carriage 27 disposed under the document laying base 12.

The first carriage 27 is disposed so that the carriage can move parallel to the document laying base 12, and is moved to reciprocate under the document laying base 12 by a scanning motor (not shown) via a toothed belt (not shown).

Moreover, a second carriage 28 is disposed under the document laying base 12 so that the carriage can move parallel to the document laying base 12. Second and third mirrors 30, 31 which deflect the light reflected from the document D and deflected by the first mirror 26 in order are attached to the second carriage 28 at right angles to each other. The second carriage 28 is driven to move following the first carriage 27 by the toothed belt which drives the first carriage 27, and is moved at a speed of ½ along the document laying base 12 parallel to the first carriage.

Furthermore, under the document laying base 12, there are disposed an image forming lens 32 which focuses the reflected light from the third mirror 31 on the second carriage 28, and a photoelectric conversion device (CCD) 34 which receives the reflected light focused by the image forming lens 32 and photoelectrically converts the light. The image forming lens 32 is disposed in a plane including an optical axis of the light deflected by the third mirror 31 so that the lens can move via a driving mechanism. The lens moves itself, and thereby the reflected light is formed into the image at a desired magnification. Moreover, the CCD 34 photoelectrically converts the incident reflected light, and outputs an electric signal corresponding to the read document D.

On the other hand, the printer section 6 includes a laser exposure apparatus 40 which acts as latent image forming means. The laser exposure apparatus 40 includes: a semiconductor laser 41 as a light source; a polygon mirror 36 as a scanning member which continuously deflects a laser beam emitted from the semiconductor laser 41; a polygon motor 37 as a scanning motor which rotates/drives the polygon mirror 36 at a predetermined rotation number; and an optical system 42 which deflects the laser beam from the polygon mirror 36 and guides the beam onto a photosensitive drum 44 described later. The laser exposure apparatus 40 constituted in this manner is fixed to/supported by a support frame (not shown) of the apparatus main body 10.

The semiconductor laser 41 is controlled to turn on/off in accordance with the image information of the document D read by the scanner section 4, or facsimile transmitted/received document information. The laser beam is directed to the photosensitive drum 44 via the polygon mirror 36 and optical system 42 to scan a peripheral surface of the photosensitive drum 44 so that an electrostatic latent image is formed on the peripheral surface of the photosensitive drum 44.

Moreover, the printer section 6 includes the freely rotatable photosensitive drum 44 as an image bearer disposed substantially in the middle of the apparatus main body 10. The peripheral surface of the photosensitive drum 44 is exposed to the laser beam from the laser exposure apparatus 40 so that a desired electrostatic latent image is formed. In the periphery of the photosensitive drum 44, there are disposed in order: an electric charger 45 which electrostatically charges the drum peripheral surface at a predetermined charge; a development unit 46 which supplies a toner as a developer to the electrostatic latent image formed on the peripheral surface of the photosensitive drum 44 to develop the image at a desired image density; a transfer charger 48 which integrally includes a separation charger 47 for separating a transfer material supplied from a sheet cassette described later, that is, a copy sheet P from the photosensitive drum 44 and which transfers a toner image formed on the photosensitive drum 44 onto the sheet P; a separation claw 49 which separations the copy sheet P from the peripheral surface of the photosensitive drum 44; a cleaning apparatus 50 which cleans the toner remaining on the peripheral surface of the photosensitive drum 44; and a static eliminator 51 which eliminates electricity from the peripheral surface of the photosensitive drum 44.

In a lower part of the apparatus main body 10, an upper cassette 52, middle cassette 53, and lower cassette 54 are disposed in a stacked state so that the respective cassettes can be drawn from the apparatus main body, and the copy sheets having different sizes are charged in the respective cassettes. A large-capacity feeder (LCF) 55 is disposed beside these cassettes, and about 3000 copy sheets P having a size for frequent use, such as the copy sheets P having A4 size, are contained in this large-capacity feeder 55. Moreover, a sheet supply cassette 57 which also serves as a manual feed tray (SFB) 56 is mounted above the large-capacity feeder 55 in a freely detachable/attachable manner.

In the apparatus main body 10, a conveyance path 58 is formed to extend through a transfer section positioned between the photosensitive drum 44 and transfer charger 48 from each cassette and large-capacity feeder 55, and a fixing unit 60 including a fixing lamp 60a is disposed in a terminal end of the conveyance path 58.

A discharge port 61 is formed in the side wall of the apparatus main body 10 disposed opposite to the fixing unit 60.

In the vicinity of the upper cassette 52, middle cassette 53, lower cassette 54, and sheet supply cassette 57 and in the vicinity of the large-capacity feeder 55, pickup rollers 63 are disposed which extract the sheets P from the cassettes and large-capacity feeder 55 sheet by sheet. Moreover, in the conveyance path 58, a large number of sheet supply roller pairs 64 are disposed to convey the copy sheet P extracted by the pickup roller 63 through the conveyance path 58.

A resist roller pair 65 is disposed on the upstream side of the photosensitive drum 44 in the conveyance path 58. The resist roller pair 65 corrects the inclination of the extracted copy sheet P, aligns the tip end of the toner image on the photosensitive drum 44 with the tip end of the copy sheet P, and supplies the copy sheet P to the transfer section at the same speed as a movement speed of the peripheral surface of the photosensitive drum 44. A pre-aligning sensor 66 is disposed to detect the reaching of the copy sheet P before the resist roller pair 65, that is, on a sheet supply rollers 64 side.

The copy sheets P extracted sheet by sheet from each cassette or the large-capacity feeder 55 by the pickup roller 63 are fed to the resist roller pair 65 from the sheet supply roller pair 64. Subsequently, after the tip end of the copy sheet P is aligned by the resist roller pair 65, the sheet is fed to the transfer section.

In the transfer section, a developer image formed on the photosensitive drum 44, that is, the toner image is transferred onto the sheet P by the transfer charger 48. The copy sheet P onto which the toner image has been transferred is separated from the peripheral surface of the photosensitive drum 44 by the actions of the separation charger 47 and separation claw 49, and conveyed into the fixing unit 60 via a conveyance belt 67 constituting a part of the conveyance path 58. Subsequently, after the developer image is molten/fixed onto the copy sheet P by the fixing unit 60, the copy sheet P is discharged onto a finisher 150 by a sheet supply roller pair 68 and sheet discharge roller pair 69 through the discharge port 61.

Under the conveyance path 58, an automatic double-sided unit (ADU) 70 is disposed to reverse the copy sheet P passed through the fixing unit 60 and feed the sheet again to the resist roller pair 65. The automatic double-sided unit 70 includes: a temporary accumulation portion 71 in which the copy sheet P is temporarily accumulated; a reverse path 72 which is branched from the conveyance path 58 to reverse the copy sheet P passed through the fixing unit 60 and to guide the sheet into the temporary accumulation portion 71; a pickup roller 73 which extracts the copy sheets P accumulated in the temporary accumulation portion sheet by sheet; and sheet supply rollers 75 which supply the extracted sheet to the resist roller pair 65 through a conveyance path 74. Moreover, in a branch portion of the conveyance path 58 and reverse path 72, a distribution gate 76 is disposed to selectively distribute the copy sheets P to the discharge port 61 or reverse path 72.

To perform a double-sided copy, the copy sheet P passed through the fixing unit 60 is guided to the reverse path 72 by the distribution gate 76, temporarily accumulated in the temporary accumulation portion 71 in a reversed state, and thereafter fed to the resist roller pair 65 by the pickup roller 73 and sheet supply roller pair 75 through the conveyance path 74. Subsequently, the copy sheets P is aligned by the resist roller pair 65 and again fed to the transfer section so that the toner image is transferred onto the back surface of the copy sheet P. Thereafter, the copy sheet P is discharged onto the finisher 150 via the conveyance path 58, fixing unit 60, and sheet discharge rollers 69.

In the finisher 150, discharged documents constituting one copy are stapled and stored by a unit of one copy. Every time one copy sheet P to be stapled is discharged via the discharge port 61, the sheet is shifted and aligned by a guide bar 151 on a staple side. When all the sheets are completely discharged, a sheet press arm 152 presses the discharged copy sheets P by the unit of one copy, and a stapler unit (not shown) staples the sheets. Thereafter, the guide bar 151 is lowered, and the stapled copy sheets P are discharged onto a finisher discharge tray 154 by a finisher discharge roller 155 by one copy unit. A lowered amount of the finisher discharge tray 154 is determined to a certain degree by the number of discharged copy sheets P. Every time one copy unit of sheets is discharged, the tray is lowered in a stepwise manner. Moreover, the guide bar 151 for aligning the discharged copy sheets P is in a height position such that the bar does not contact the already stapled copy sheets P laid on the finisher discharge tray 154.

Moreover, the finisher discharge tray 154 is connected to a shift mechanism (not shown) which shifts (e.g., in four forward/backward/left/right directions) every copy in a soft mode.

Furthermore, in an upper part of a front surface of the apparatus main body 10, an operation panel 80 is disposed into which various copy conditions and copy start signal for starting a copy operation are input.

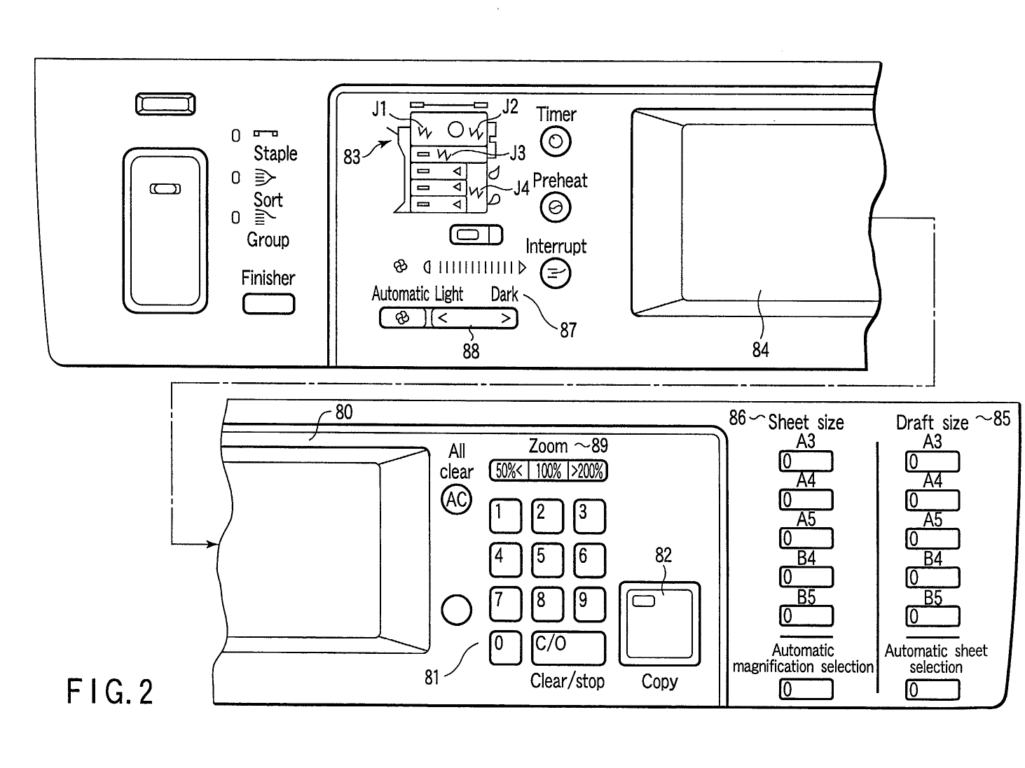

As shown in FIG. 2, the operation panel 80 includes numeric keys 81, copy key 82, state display portion 83, liquid crystal display portion 84, document size setting keys 85, sheet size setting keys 86, density display portion 87, density setting keys 88, and magnification setting keys 89.

The numeric keys 81 set the number of document sheets or copy sheets.

The copy key 82 instructs a copy start.

The state display portion 83 guides/displays a selection state of the sheet supply cassette, or a document or sheet jam.

Moreover, as described later in detail, when the jam of the sheets occurs, an LED (not shown) of a jam place of the state display portion 83 blinks.

A blinking sheet jam indicator J1 informs that the sheet jam has occurred on the sheet conveyance path on the left side in the apparatus body.

A blinking sheet jam indicator J2 informs that the sheet jam has occurred on the sheet conveyance path on the right side in the apparatus body.

A blinking sheet jam indicator J3 informs that the sheet jam has occurred in the automatic double-sided unit.

A blinking sheet jam indicator J4 informs that the sheet supplied from the selected front cassette is jammed.

The liquid crystal display portion 84 displays the number of document sheets or copy sheets, displays a copy magnification or edition, or shows various operation guidance. The liquid crystal display portion 84 includes a touch panel in which various operation instructions can be inputted by inputs of selection keys. For example, the selection keys of document modes such as a photograph mode, character mode, and character/photograph mode are displayed so that the input is possible.

Moreover, as described later in detail, when jamming of a sheet occurs, the liquid crystal display portion 84 displays guidance of a jam cleaning process.

The document size setting keys 85 set the size of the document D.

The sheet size setting keys 86 set the size of the sheet P.

The density display portion 87 displays the copy density set by the density setting keys 88.

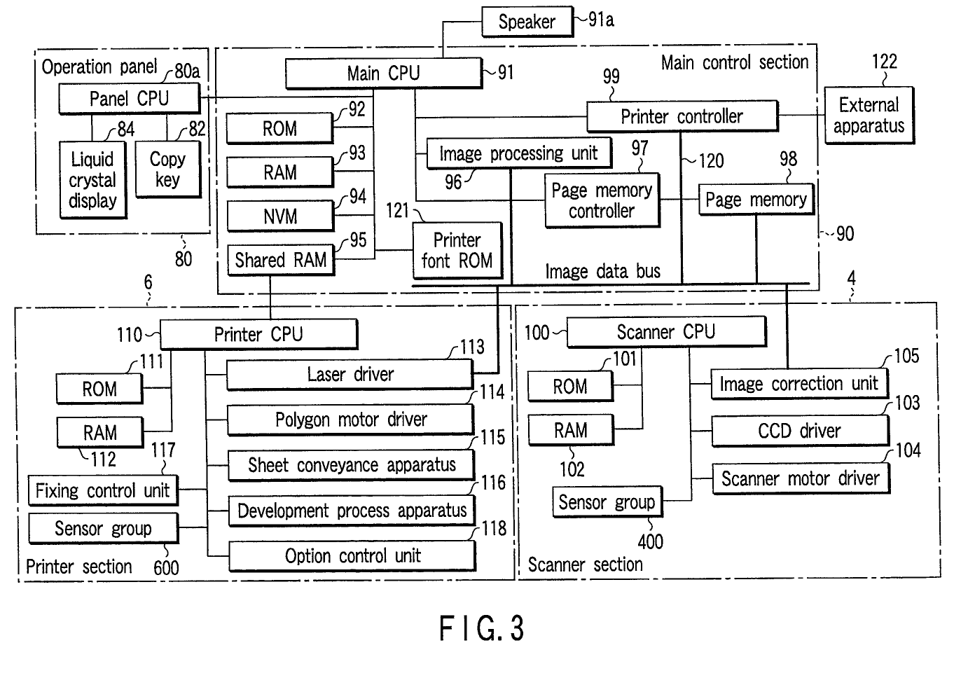

FIG. 3 shows a block diagram schematically showing an electric connection of the digital multi functional peripheral in FIG. 1 and a flow of a signal for control. According to FIG. 3, a digital copy machine is constituted of three CPUs including a main CPU 91 in a main control section 90, a scanner CPU 100 of the scanner section 4, and a printer CPU 110 of the printer section 6. The main CPU 91 performs a bidirectional communication with the printer CPU 110 via a shared RAM 95, the main CPU 91 issues an operation instruction, and the printer CPU 110 returns a status. The printer CPU 110 and scanner CPU 100 perform a serial communication, the printer CPU 110 issues the operation instruction, and the scanner CPU 100 returns the status.

The operation panel 80 is connected to the main CPU 91 via a panel CPU 80a.

The main control section 90 includes the main CPU 91, a ROM 92, a RAM 93, a NVM 94, the shared RAM 95, an image processing unit 96, a page memory controller 97, a page memory 98, a printer controller 99, and a printer font ROM 121.

The main CPU 91 controls the whole main control section 90. In the ROM 92, a control program is stored. In the RAM 93, data is temporarily stored.

The nonvolatile RAM (NVM) 94 is a nonvolatile memory backed up a battery (not shown). When power is turned off, the data in the NVM 94 is held.

The shared RAM 95 is used to perform the bidirectional communication between the main CPU 91 and printer CPU 110.

The page memory controller 97 stores or reads out the image data with respect to the page memory 98. The page memory 98 has an area in which the image data for a plurality of pages can be stored, and is formed so that data obtained by compressing the image data from the scanner section 4 can be stored for each page.

In the printer font ROM 121, font data corresponding to print data is stored.

The printer controller 99 uses the font data stored in the printer font ROM 121 to develop the print data from an external apparatus 122 such as a personal computer into the image data at a resolution corresponding to data indicating the resolution imparted to the print data.

The scanner section 4 includes: the scanner CPU 100 which controls the whole scanner section 4; a ROM 101 in which the control program is stored; a RAM 102 for storing data; a CCD driver 103 which drives the CCD sensor 34; a scanner motor driver 104 which controls the rotation of the motor to move the exposure lamp 25 and mirrors 26, 27, 28; and an image correction unit 105 including an analog-to-digital conversion circuit which converts an analog signal from the CCD sensor 34 into a digital signal, shading correction circuit for correcting a fluctuation of a threshold level caused by a dispersion of the CCD sensor 34 or an ambient temperature change with respect to an output signal from the CCD sensor 34, and a line memory in which the digital signal subjected to a shading correction from the shading correction circuit is once stored.

Moreover, the scanner section 4 includes a sensor group 400 which detects jams such as a document jam as described later in detail.

The printer section 6 includes: the printer CPU 110 which controls the whole printer section 6; a ROM 111 in which the control program is stored; a RAM 112 for storing data; a laser driver 113 which turns on/off light emission by the semiconductor laser 41; a polygon motor driver (motor control apparatus) 114 which controls the rotation of the polygon motor 37 of the laser unit 40; a sheet conveyance unit 115 which control the conveyance of the sheet P by the conveyance path 58; a development process unit 116 using the electric charger 45, development unit 46, and transfer charger 48 to perform electric charge, development, and transfer; a fixing control unit 117 which controls the fixing unit 60; and an option control unit 118.

Moreover, the printer section 6 includes a sensor group 600 which detects the jams such as a sheet jam as described later in detail.

Furthermore, the image processing unit 96, page memory 98, printer controller 99, image correction unit 105, and laser driver 113 are connected via an image data bus 120.

An outline of the present invention in this constitution will next be described.

For example, when the jam of the sheet occurs, the liquid crystal display portion 84 displays the guidance of a jam cleaning, and the state display portion 83 blinks/displays the jam place. Then, when a user performs an operation of the jam cleaning, and if a wrong cover is opened or a wrong operation is performed with respect to the jam place, this is notified by a voice or error sound. Thereby, the user can quickly perform a recovery operation without confirming the liquid crystal display portion 84.

That is, the cover or tray is opened during the recovery operation, and it is then judged whether or not a sensor (one sensor or a plurality of sensors) responding to this is related to the jam cleaning. With the unrelated sensor (one sensor or a plurality of sensors), the user is informed by voice guidance or error sound that the operation is wrong.

With the response of the correct sensor related to the jam cleaning, no sound is made. Moreover, it is optionally possible to set a correct action sound, or voice guidance of a correct action.

Concretely, when the jam occurs, the main CPU 91 specifies the sensor having sensed the jam, and executes a program to determine an order of priority at a cover open time.

When the user takes an action such as the opening of the cover against the order of priority after the jam occurrence, the main CPU 91 notifies guidance via a speaker 91a. Conversely, when the user takes an action such as the cover opening suitable for the order of priority, it is optionally possible to execute the notice of the guidance via the speaker 91a.

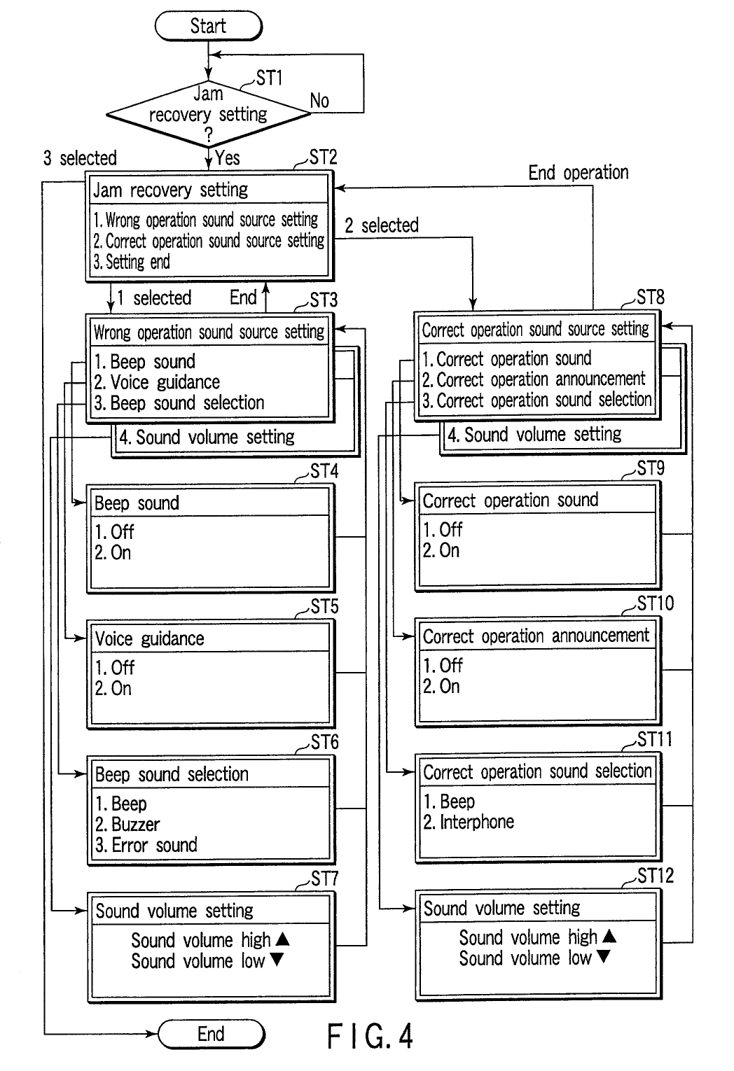

A setting for notifying the guidance via the speaker 91a as a sound source will next be described with reference to a screen flow of FIG. 4.

When a “jam recovery setting” is selected from a menu display of the liquid crystal display portion 84 (ST1), the main CPU 91 displays a screen of “jam recovery setting” on the liquid crystal display portion 84 (ST2). On the screen of “jam recovery setting”, “1. Wrong operation sound source setting”, “2. Correct operation sound source setting”, and “3. Setting end” are displayed so that they can be selected.

Here, when “1. Wrong operation sound source setting” is selected, the main CPU 91 displays a screen of “wrong operation sound source setting” on the liquid crystal display portion 84 (ST3). In the screen of “wrong operation time sound source setting”, “1. Beep sound”, “2. Voice guidance”, “3. Beep sound selection”, and “4. Sound volume setting” are displayed so that they can be selected.

When “1. Beep sound” is selected, the main CPU 91 displays a screen of “Beep sound” on the liquid crystal display portion 84 (ST4). On the screen of “Beep sound”, “1. Off” and “2. On” are displayed so that they can be selected. Here, when the operation of “setting” or “cancel” is performed, the process returns to step ST3.

When “2. Voice guidance” is selected in step ST3, the main CPU 91 displays a screen of “voice guidance” on the liquid crystal display portion 84 (ST5). On the screen of “voice guidance”, “1. Off” and “2. On” are displayed so that they can be selected. Here, when the operation of “setting” or “cancel” is performed, the process returns to step ST3.

When “3. Beep sound selection” is selected in step ST3, the main CPU 91 displays a screen of “Beep sound selection” on the liquid crystal display portion 84 (ST6). In the screen of “Beep sound selection”, “1. Beep”, “2. Buzzer”, and “3. Error sound” are displayed so that they can be selected. Here, when the operation of “setting” or “cancel” is performed, the process returns to step ST3.

When “4. Sound volume setting” is selected in step ST3, the main CPU 91 displays the screen of “sound volume setting” in the liquid crystal display portion 84 (ST7). In the screen of “sound volume setting”, “Sound volume high ▴” and “Sound volume low ▾” are displayed, and the sound volume can be adjusted. Here, when the operation of “setting” or “cancel” is performed, the process returns to step ST3.

When the setting in step ST3 ends, and an end operation is performed, the main CPU 91 displays the screen of “jam recovery setting” of step ST2 on the liquid crystal display portion 84.

Here, when “2. Correct operation sound source setting” is selected, the main CPU 91 displays a screen of “correct operation sound source setting” on the liquid crystal display portion 84 (ST8). On the screen of “correct operation sound source setting”, “1. Correct action sound”, “2. Correct action announcement”, “3. Correct action sound selection”, and “4. Sound volume setting” are displayed so that they can be selected.

When “1. Correct action sound” is selected, the main CPU 91 displays a screen of “correct action sound” on the liquid crystal display portion 84 (ST9). On the screen of “correct action sound”, “1. Off” and “2. On” are displayed so that they can be selected. Here, when the operation of “setting” or “cancel” is performed, the process returns to step ST8.

When “2. Correct action announcement” is selected in the step ST8, the main CPU 91 displays a screen of “correct action announcement” on the liquid crystal display portion 84 (ST10). On the screen of “correct action announcement”, “1. Off” and “2. On” are displayed so that they can be selected. Here, when the operation of “setting” or “cancel” is performed, the process returns to step ST8.

When “3. Correct action sound selection” is selected in step ST8, the main CPU 91 displays a screen of “correct action sound selection” on the liquid crystal display portion 84 (ST1). On the screen of “correct action sound selection”, “1. Beep” and “2. Interphone” are displayed so that they can be selected. Here, when the operation of “setting” or “cancel” is performed, the process returns to the ST8.

When “4. Sound volume setting” is selected in step ST8, the main CPU 91 displays a screen of “sound volume setting” on the liquid crystal display portion 84 (ST12). On the screen of “sound volume setting”, “sound volume high ▴” and “sound volume low ▾” are displayed, and the sound volume can be adjusted. Here, when the operation of “setting” or “cancel” is performed, the process returns to step ST8.

When the setting in step ST8 ends, and the end operation is performed, the main CPU 91 displays the screen of “jam recovery setting” of the ST2 on the liquid crystal display portion 84. Here, when “3. Setting end” is selected, the main CPU 91 ends the jam recovery setting.

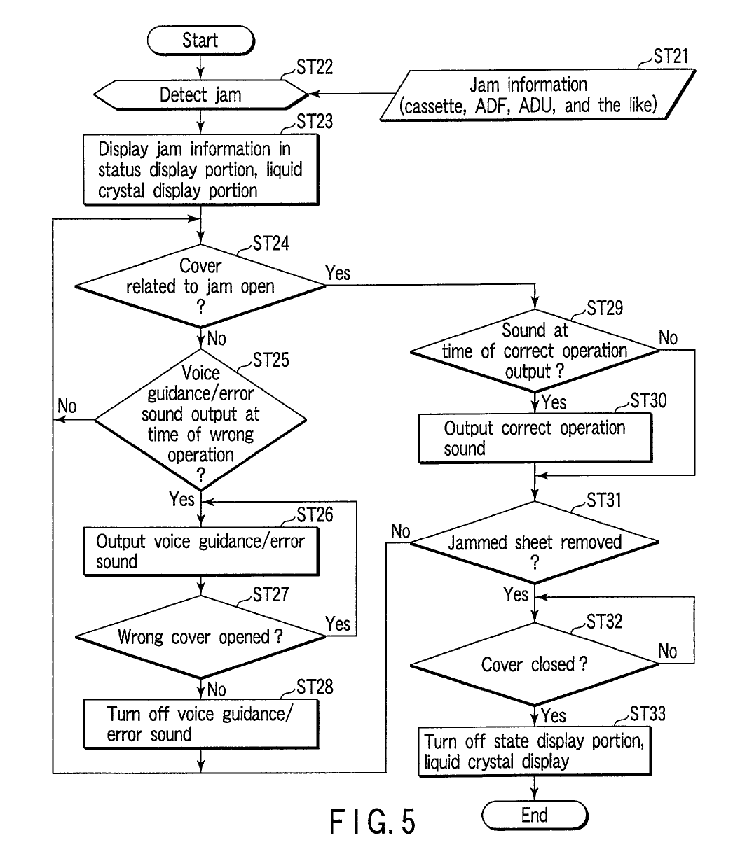

A jam recovery operation in the digital multi functional peripheral in which the wrong and correct operation sound sources are selected as described above will next be described with reference to a flowchart of FIG. 5.

First, it is assumed that a sheet jam has occurred in the sheet supply cassettes 52 to 54, large-capacity feeder 55, manual feed tray 56, sheet supply cassette 57, ADF 7, and ADU 70. As a result, when a detection signal (jam information) is received from the sensor units 400, 600 (ST21), the main CPU 91 detects the jam (ST22), and displays the jam information on the state display portion 83, and liquid crystal display portion 84 (ST23).

Here, the user opens a cover unrelated to the jam (ST24), and the main CPU 91 then judges the wrong operation, and checks whether the above-described setting relates to the outputting of the voice guidance or error sound at the time of wrong operation (ST25).

If voice guidance is set at the time of wrong operation, the main CPU 91 performs the voice guidance. If the error sound is set at the time of wrong operation, the error sound is output (ST26).

As a result, when the user closes the (wrong) cover unrelated to the jam (ST27), the main CPU 91 turns off the voice guidance or error sound at the time of wrong operation (ST28).

In step ST24, the user opens a cover related to the jam, and the main CPU 91 checks whether or not the sound is to be output at the time of correct action in the above-described setting (ST29). It is to be noted that a correct action announcement may also be output as described above at the time of correct action.

When output of the correct action sound is set, the main CPU 91 outputs the correct action sound (ST30).

Subsequently, when the jammed sheet is removed (ST31) and the cover is closed (ST32), the main CPU 91 turns off the display of the jam information in the state display portion 83 and liquid crystal display portion 84 (ST33) and ends the jam cleaning process.

An operation example of the jam cleaning process (jam recovery operation) will next be described. In this case, the main CPU 91 detects the sheet jam by the sensor unit 600, and blinks the sheet jam indicator J4 in the state display portion 83 in the operation panel 80 shown in FIG. 2.

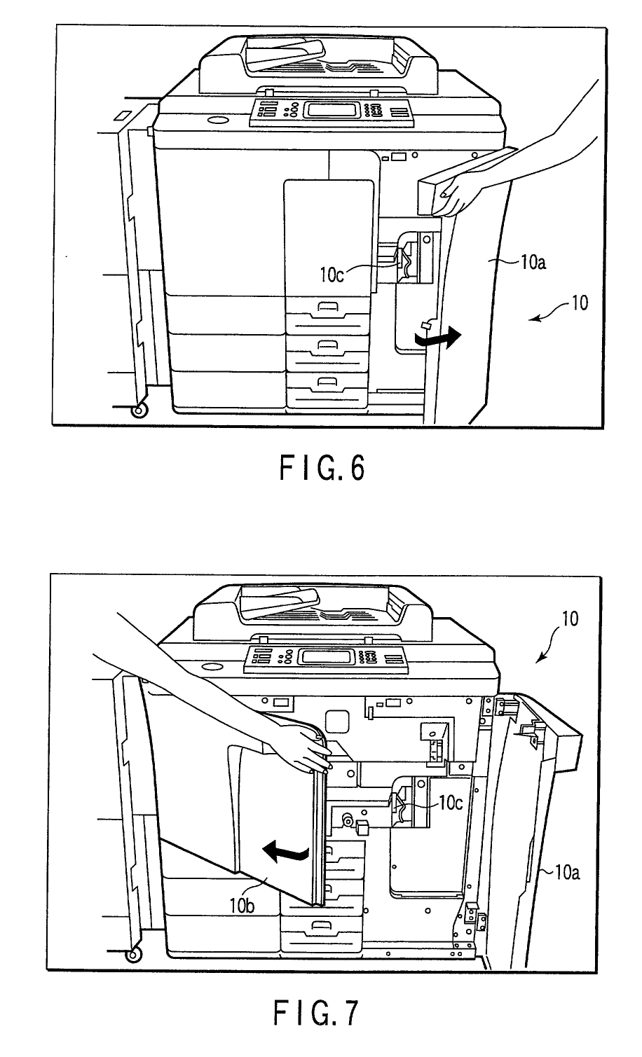

Here, for the jam cleaning process, as shown in FIG. 6, the user holds the upper part of the door of the apparatus main body 10 and opens a front cover 10a.

In this case, the main CPU 91 detects that the front cover 10a has been opened from the sensor unit 600. Since this is related to the jam cleaning process, the correct action sound is output. In this case, the sound is output, for example, for about three seconds.

Subsequently, as shown in FIG. 7, the user opens a front cover 10b of the apparatus main body 10.

In this case, the main CPU 91 detects the opening of the front cover 10b from the sensor unit 600, but this operation is not related to the jam cleaning process, and therefore the error sound is output.

When the user closes the front cover 10b as a result of the error sound, the main CPU 91 detects this in the sensor unit 600 and stops the error sound.

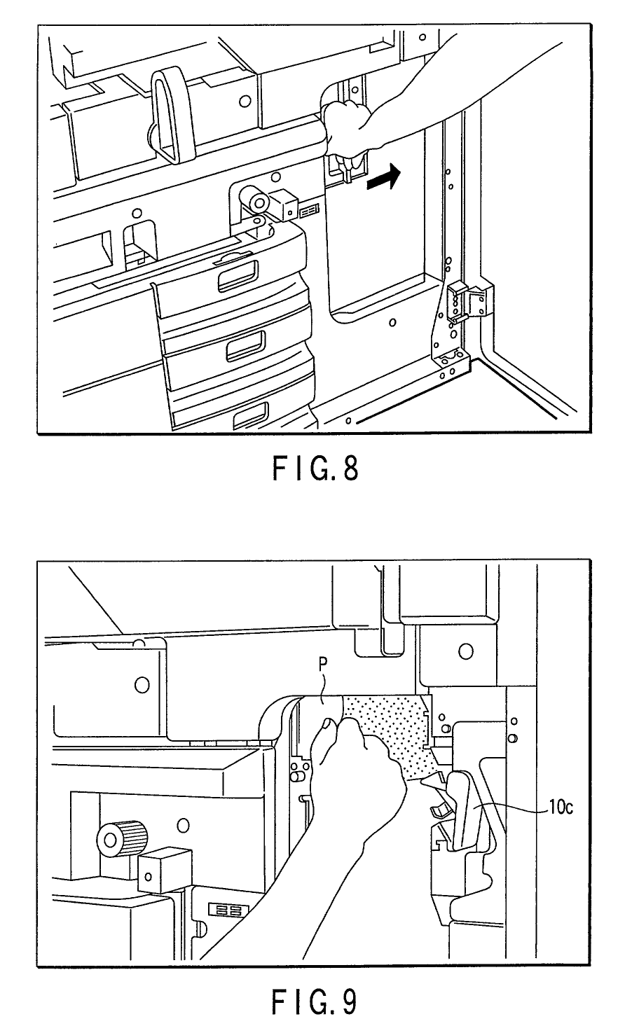

Subsequently, as shown in FIG. 8, the user pulls a lock lever 10c shown in FIG. 6, and moves the large-capacity feeder 55 toward the right side until the feeder stops.

Furthermore, when the sheet P is jammed inside, the user removes the jammed sheet as shown in FIG. 9.

Finally, the user returns the large-capacity feeder 55 to its original position, locks the feeder, and closes the front cover 10a.

The main CPU 91 detects by the sensor unit 600 that the front cover 10a is closed, turns off the display of the jam information in the state display portion 83 and liquid crystal display portion 84 to end the jam cleaning process, and returns to the control of the copy operation.

As described above, according to the above-described embodiment of the present invention, instead of directing the process procedure at the jam occurrence time in one direction from the copy machine, the sound is made so that the digital copy machine is corrected with respect to the jam process operation performed by the user. Thereby, the user's jam cleaning operation can be speeded up and clarified.

It is to be noted that not only an image forming apparatus but also a facsimile apparatus may be used to obtain a similar effect according to the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image forming apparatus which reads an image of a document and forms an image on a supplied sheet based on the read image, the apparatus comprising:
a detection unit which detects a conveyance error of the document or sheet;
a judgment unit to judge whether a resetting process is a correct or wrong resetting process, when the resetting process is performed with respect to the conveyance error detected by the detection unit;
a first notification unit to notify that the resetting process is correct, when the judgment unit judges the resetting process to be correct; and
a second notification unit to notify that the resetting process is wrong, when the judgment unit judges the resetting process to be wrong.

2. An image forming apparatus according to claim 1, wherein the detection unit includes a sensor group to detect that a cover constituting the image forming apparatus is opened/closed.

3. An image forming apparatus according to claim 1, wherein the detection unit includes a display unit which displays an occurrence place of the conveyance error by a detection signal from a sensor group.

4. An image forming apparatus according to claim 1, wherein the judgment unit stores the resetting process procedure with respect to the conveyance error detected by the detection unit beforehand, and judges whether the resetting process is correct or wrong in comparison with the resetting process procedure.

5. An image forming apparatus according to claim 1, wherein the judgment unit stores an order of priority of the resetting process with respect to the conveyance error detected by the detection unit, and judges whether the resetting process is correct or wrong in comparison with the order of priority of the resetting process.

6. An image forming apparatus according to claim 1, wherein the first notification unit notifies that the resetting process is correct in accordance with a preset notification method.

7. An image forming apparatus according to claim 1, wherein the first notification unit makes a preset notification sound only for a predetermined time.

8. An image forming apparatus according to claim 1, wherein the first notification unit notifies a preset announcement indicating that the resetting process is correct.

9. An image forming apparatus according to claim 1, wherein the first notification unit does not notify anything, when a preset notification method is turned off.

10. An image forming apparatus according to claim 1, wherein the second notification unit notifies that the resetting process is wrong in accordance with a preset notification method.

11. An image forming apparatus according to claim 1, wherein the second notification unit makes a preset error sound.

12. An image forming apparatus according to claim 1, wherein the second notification unit notifies a preset voice guidance.

13. An image forming apparatus according to claim 1, wherein the second notification unit does not notify anything, when a preset notification method is turned off.

14. An error resetting method of an image forming apparatus which reads an image of a document and forms an image on a supplied sheet based on the read image, the method comprising:
detecting a conveyance error of the document or sheet;
judging whether a resetting process is a correct or wrong resetting process, when the resetting process is performed with respect to the detected conveyance error;
notifying that the resetting process is correct, when the resetting process is judged to be correct; and
notifying that the resetting process is wrong, when the resetting process is judged to be wrong.
